(19) United States
(12) Patent Application Publication
(10) Pub. No.: US 2003/0226733 A1
(43) Pub. Date: Dec. 11, 2003

(54) Sliding clutch for a device for transferring a film from a backing tape

(75) Inventors: Winfried Huthmacher, Frankfurt/Main (DE); Roland Schneider, Kelkheim (DE)

Correspondence Address: PENNIE & EDMONDS LLP, 1667 K STREET NW, SUITE 1000, WASHINGTON, DC, 20006

(73) Assignees: BIC Deutschland GmbH & Co., Liederbach (DE); BICH-DUFOUR, Clichy (FR)

(21) Appl. No.: 10/379,653

(22) Filed: Mar. 6, 2003

Related U.S. Application Data
(63) Continuation of application No. PCT/EP01/05671, filed on May 17, 2001.

(30) Foreign Application Priority Data
Sep. 8, 2000 (EP) EP 00 119 642.7

(51) Int. Cl. F16D 7/02

(52) U.S. Cl. 192/56.1; 464/30

(57) ABSTRACT

The invention relates to a sliding clutch for torsion-limiting force transmission between a reel and a rotating part which have two bearing members disposed concentrically within one another. One of the bearing elements is formed by a circular bearing sleeve which is radially resiliently deformable transverse to its rotational axis. The bearing sleeve and the opposing bearing member abut each other in the region of a circular joint and the force transmission is effected by frictional slaving in the region of the joint. With a view to improving the frictional slaving, a tensioning element is provided on the side of the bearing sleeve opposite the side adjacent the bearing member such that the tensioning element presses against the bearing sleeve to bias the bearing sleeve against the opposing bearing member.

### CROSS-REFERENCE TO RELATED APPLICATIONS

This application is a continuation of the U.S. national stage designation of copending International Patent Application PCT/EP01/05671, filed May 17, 2001, which claims the benefit of European Patent Application EP 00119642.7, filed Sep. 8, 2000, the entire contents of which are expressly incorporated herein by reference thereto.

### FIELD OF THE INVENTION

The invention relates to a sliding clutch such as for a hand-held device for transferring a film from a backing tape onto a substrate.

### BACKGROUND OF THE INVENTION

A sliding clutch of this type is described in U.S. Pat. No. 4,891,090 to Lorinez et al. (corresponding to EP 0 362 697 A1). This known sliding clutch is disposed between a rotary drive member for a supply reel with the sliding clutch comprising two bearing members arranged concentrically within one another, one of these bearing members having the form of a round ring and the other bearing member being formed by a hollow cylindrical reel body. The round ring is made up of a plurality of annular segments formed by radial and axial slots which extend axially in one piece from a toothed disc while engaging concentrically in the hollow cylindrical reel body. It is guaranteed that slidable torsional slaving can be achieved by the ring segments pressing radially against the inner shell surface of the hollow cylindrical reel body with a certain amount of tensional force at its free end portions as a result of a prefabricated oversized portion.

In this known sliding clutch, it is difficult to predetermine the size of the torque at which the transmission force is to be limited. This is caused by the level having to be predetermined during manufacture of the annular segments as they have to be produced with a radially oversized section so that they abut such that they are elastically pushed together with a radial bias at the inner shell surface of the reel body in the mounted position. In doing so, it has to be taken into consideration that even slight angular deviations of the annular segments can lead to a considerable radial change in position of their effective friction surfaces and a predetermined torque restriction can therefore only be implemented within a large tolerance range. In addition, in the known design, one has to expect alterations in tension caused by relatively high stress existing at the connection point between the annular segments and the toothed disc because of the desired small design which, for one thing, is inclined to decrease stress because of the material becoming fatigued and, for another thing, leans towards an unintentional increase or decrease in frictional tension as a result of changes in shape caused by differences in temperature. For reasons connected with handling and the defect-free transportation of the backing tape and the film, it is however desired to achieve as uniform a tension of the frictional surfaces on one another and as uniform a torque slaving as possible.

U.S. Pat. No. 6,145,770 to Manusch et al. (corresponding to EP 0 883 564 B1) describes a sliding clutch for torque-limiting force transmission between a reel core and a reel for winding up or unwinding a tape which has two rotating parts arranged concentrically within one another, one of which has the shape of an oval ring with an annular wall which is radially elastically deformable towards the rotational axis and where the torsional force is transmitted by frictional slaving between the oval annular wall and the other bearing member provided in the form of a polygon. In this known structure, the ring is severely deformed and a concentric bearing of the rotating parts is not guaranteed either.

A need exists for improving the frictional slaving of a sliding clutch of the type described above while guaranteeing a simple concentric mounting. A need also exists for the improved torque-limiting transmission of force and to make it easier to predetermine the force more precisely. Furthermore, the sliding clutch should have a long lifetime with the maximum transferable torque of the force transmission not substantially changing over a longer period of time or remaining constant.

### SUMMARY OF THE INVENTION

The present invention is directed to a tensioning element provided between a circular bearing sleeve and a bearing member. The tensioning element is arranged on the side of the bearing sleeve opposite the bearing member such that it presses elastically against the bearing sleeve and is thereby resiliently deformed or bends, thus elastically biasing the bearing sleeve against the bearing member. This creates frictional slaving where the circular bearing sleeve is only very slightly resiliently deformed, namely by the amount of play of the joint, wherein this measurement is just a few tenths of a millimeter and can theoretically be zero so that the radial elastic deforming or bending of the bearing sleeve is also very small and can theoretically be zero. Consequently, the elastic deforming of the tensioning element in the sense described above found in the embodiment according to the invention is also low or non-existent. Changes in tension at the bearing sleeve and at the tensioning element caused by material fatigue are therefore slight and not damaging, thus the desired long product life is achieved. In addition, the frictional surfaces form a simple concentric pivot bearing for the bearing members during sliding of the sliding clutch.

The effectiveness of the tensional force of the tensioning element can be increased or the necessary tensional force of the tensioning element can be reduced when the tensioning element is formed by a free section of the bearing sleeve which preferably extends in the longitudinal direction of the rotational axis and can be separated from the other part of the bearing sleeve by a joint or gap, especially in the form of a tongue. The partial separation from the bearing sleeve causes the free section to be connected at one end to the bearing sleeve which means that it not only cannot be lost but it is also connected in a radially resiliently flexible manner. The bearing sleeve can comprise one or several free sections which are preferably formed by one or more segments.

The tensioning element is preferably formed to be ring-shaped. The annular form can serve to hold the tensioning element itself. In addition, the annular form also means that the tensioning element can essentially spread apart or press together one or more free sections or segments distributed around the periphery more or less equally. The tensioning element is preferably formed by a quartered annular spring or a helical spring in the form of a tension or compression spring. Within the boundaries of the invention, the bearing sleeve can be disposed outside or inside the other bearing member. If the bearing sleeve is disposed inside, the other bearing member is also formed by a hollow cylindrical bearing sleeve. If the circular annular wall is disposed outside, the other bearing member can also be formed as a hollow cylindrical bearing sleeve.

Owing to the low deformation of the bearing sleeve and the tensioning element that follows it, especially when the tensioning element is formed in an annular fashion, frictional tension with a relatively small tolerance can be achieved by prefabricating the associated parts. In addition, the frictional tension remains constant, even after a long lifetime.

The sliding clutch used in the invention is particularly suitable for torque-limiting transmission of force between a reel and a rotating member of a hand-held device for applying a film from a backing tape onto a substrate. This sliding clutch can be associated to a supply reel or a take-up reel of the handpiece. The sliding clutch used in the invention is ideally suited to such a hand-held device because it has a construction which is small and inexpensive to produce and can be integrated excellently into a hand-held device.

### BRIEF DESCRIPTION OF THE DRAWINGS

Preferred features of the present invention are disclosed in the accompanying drawings, wherein similar reference characters denote similar elements throughout the several views, and wherein:

FIG. 1 shows a hand-held device for applying a film from a backing tape onto a substrate having a sliding clutch as described in the invention, the hand-held device being situated in its use position and a separable or opened housing of the hand-held device being illustrated open to one side;

FIG. 2 shows a cross-sectional view along line II-II of FIG. 1;

FIG. 3 shows a take-up reel in a perspective side view;

FIG. 4 shows a view similar to that of FIG. 2, but in a modified configuration;

FIG. 5 shows a side view of a tensioning element of the sliding clutch in enlarged form;

FIG. 6 shows a tensioning element of FIG. 4 in a modified configuration; and

FIG. 7 shows a diagram illustrating the stress course versus time.

### DETAILED DESCRIPTION OF THE PREFERRED EMBODIMENTS

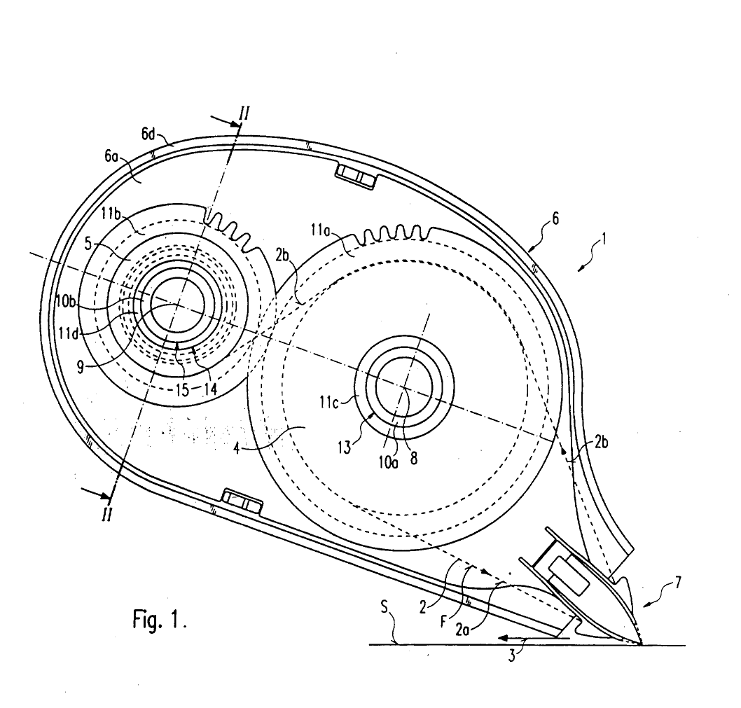

The hand-held device referred to as a whole as 1 serves to transfer a film F disposed on a backing tape 2 onto a substrate S, the backing tape 2 being disposed on a supply reel 4 and a take-up reel 5 in a housing 6 of the hand-held device 1. The housing 6 has an elongated design with an essentially rectangular cross-section and is disposed in an upright position in its functioning position as per FIG. 1, which shall be described later. An application member 7 is provided protruding from the housing 6, this member being arranged in the lower section of the front end of the housing and the backing tape 2 running about it. By pressing the preferably spatula-shaped application member 7 manually on the substrate S while at the same time pushing the hand-held device in the rearwards direction 3, the lower backing tape section 2a can be pulled off the supply reel 4 and is automatically wound back up onto the take-up reel 5 as an upper backing tape section 2b. In the present exemplified embodiment, the supply reel 4 and the take-up reel 5 are mounted so as to be rotatable about two rotational axes 8, 9 extending transversely to the deflection plane E of the backing tape 2; these axes are spaced apart from each other in the lengthwise direction of the housing 6 with the take-up reel 5 being disposed behind the supply reel 4.

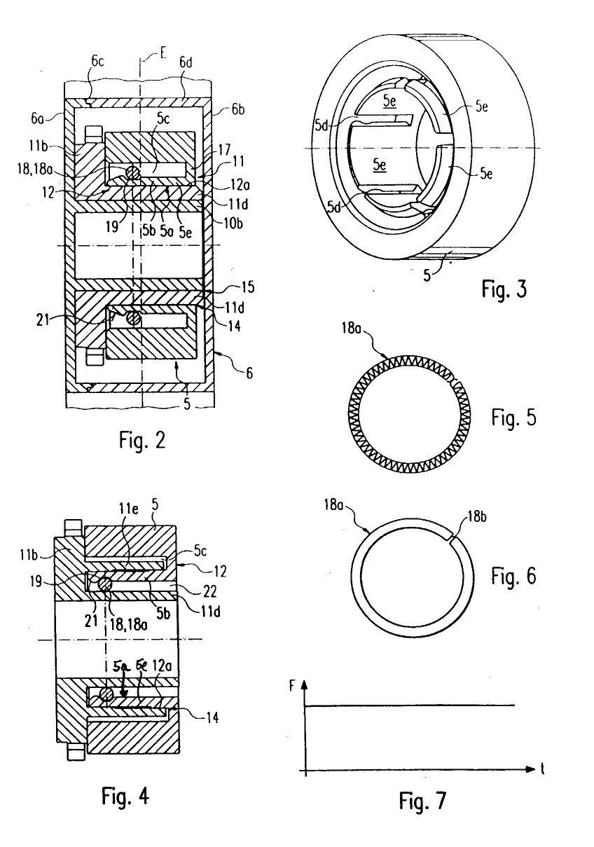

The housing 6 is made up of two housing parts 6a, 6b, the dividing joint 6c of which runs in or parallel to the deflection plane E of the backing tape. It is possible for the housing part 6b, shown for example on the right hand side in FIG. 2, to be formed with a shell-shaped peripheral wall 6d and the other housing part 6a to be essentially flat and fulfilling the function of a lid. The reels 4, 5 are rotatably mounted on pivot bearing parts 10a, 10b which project from the side walls of one of the housing parts 6a, 6b and are preferably formed by hollow cylindrical bearing sleeves molded onto side walls on both sides.

Between the reels 4, 5, there is disposed a drive connection 11 with an integrated sliding clutch 12. The drive connection 11 is formed such that—bearing in mind the respective effective winding diameters of the full and empty reels 4, 5—it drives the take-up reel 5 at such a speed that the backing tape section 2b being wound up is always slightly taut. In doing so, the sliding clutch 12 prevents the backing tape 2 from being overstretched and ripping. Once a certain effective drive torque in the drive connection 11 has been exceeded, the sliding clutch 12 activates so that, although the drive connection 11 attempts to drive the take-up reel at a higher speed, it is only driven at a speed corresponding to the speed of the backing tape 2 on the take-up surface. In the present exemplified embodiment, the drive connection 11 is formed by a toothed gearing having two meshing toothed discs 11a, 11b, each of which is rotatably mounted on the pivot bearing parts 10a, 10b with a small amount of play with a hollow cylindrical bearing sleeve 11c, 11d. The bearing sleeve 11c of the toothed disc 11a forms the supply reel 4. The latter is thus rigidly connected to the driving part of the drive connection 11 with the supply reel 4 and the toothed disc 11a having a common pivot bearing 13 which is formed by the pivot bearing parts or bearing sleeves disposed concentrically within one another.

The take-up reel 5 is mounted in a rotatable manner on the driven part of the drive connection 11 by a concentric pivot bearing 14, in this case on the driven toothed disc 11b. The pivot bearing 14 which is provided additionally to the pivot bearing 15 between the toothed disc 11b and the housing 6 is formed by two pivot bearing parts engaging concentrically within one another and in particular by hollow cylindrical bearing sleeves. The inner pivot bearing part of pivot bearing 14 is formed by the hollow cylindrical bearing sleeve 11d and the outer pivot bearing member is formed by a hollow cylindrical bearing sleeve 5a in the form of an annular wall 5b on the body of the take-up reel 5, which wall is circular on at least its inside. The bearing sleeves 11d, 5a extend in opposite axial directions to each other, one extending concentrically beyond the other socket-like with a small amount of bearing play and, in the embodiment exemplified in FIG. 2, the bearing sleeve 5a of the take-up reel 5 forming the outer bearing member. The bearing sleeve 5a is surrounded by an annular groove 5c which emerges from the body of the take-up reel 5 on the side facing the toothed disc 11b and has an axial depth which stretches over a large proportion of the width of the take-up reel 5 so that the bearing sleeve 5a is connected to the radially outer body part of the take-up reel 5 by a side flange wall 17 measuring for example a few millimeters in size.

The bearing sleeve 5a has at least one free section which is separated from the other part of the bearing sleeve 5a by a radial gap. This can for example be formed by the wall of the bearing sleeve 5a being slit by at least one slot 5d extending in an essentially axial direction which can extend as far as the bottom region of the annular groove 5c and thus to the proximity of or to the flange wall 17. The bearing sleeve 5a is preferably axially split into segments 5e by several slits 5d distributed along the periphery. These segments are integrally connected to the take-up reel 5 or the flange wall 17 in the region of their lower ends so that the top ends are radially resiliently flexible.

The bearing sleeve 5a is radially biased against the inner bearing member, in this case the bearing sleeve 11d, by a tensioning element 18 so that the inner shell surfaces of the segments 5e form slide faces which press against the associated bearing member, in this case the inner bearing sleeve 11d, with the tensional force exerted on it by the tensioning element 18. This forms the sliding clutch 12 with torque-limiting force transmission between the take-up reel 5 and the bearing sleeve 11d forming a rotary drive part.

The tensioning element 18 can be a pressure element which acts in a radially elastic way and resiliently deforms the bearing sleeve 5a at at least one position, for example at a point-focal position, and presses the bearing sleeve 5a against the bearing sleeve 11d. The tensioning element 18 can also be formed to be annular, exerting a radial force on at least one section of the circumference of the bearing sleeve 5a.

In the functioning mode, the driven drive connection part, in this case the toothed disc 11b, is driven by the supply reel 4 driven by the tape detachment wherein it carries the take-up reel 5 with it in the rotational direction as a result of the frictional slaving between the bearing sleeves 11d, 5a. When the take-up reel 5 confronts the frictional slaving with torque resistance exceeding the tape tension, the sliding clutch activates or goes into action and slides through so that the take-up reel 5 is only carried with a carrying force corresponding to the permissible tape tension and at the tape speed.

The annular tensioning element 18a exerts an essentially uniform radial pressure on all the segments 5e. This tensioning element 18 can be formed by a tension or compression element which is elastic in its longitudinal direction, for example a helical spring in the form of an open or closed ring according to FIG. 4, the spring ends of which are connected to one another, for example are hooked to one another (tension spring) or are preferably supported on one another (compression spring). The radial force acted upon the segments 5e is achieved by a thus formed tensioning ring 18a pressing the segments 5e together or spreading them apart by virtue of the tensioning ring 18a contracting or stretching in the peripheral direction.

The tensioning ring 18 can also be formed by a spring ring which acts in an elastic manner in a radial direction rather than in a circumferential direction. A spring ring made of resilient material as shown in FIG. 6 is particularly suitable for this use, this ring having a slot 18b running in the transverse direction.

The radial size of the tensioning element 18 in a relaxed state is to be measured such that the tensioning element 18 exerts the desired tension in a mounted and taut state.

The tensioning element 18 is preferably located in the outer lengthways half of the bearing sleeve 5a or in the free end region thereof, as is shown in FIG. 2. To position the tensioning ring 18a axially, an annular groove 19 can be disposed in the outer shell surface of the bearing sleeve 5a or the segments 5e. To make it easier to push the tensioning ring 18a onto the bearing sleeve 5a, the bearing sleeve has a slanted or rounded insertion surface 21 on its free end, which, on the segments 5e, are insertion surface parts. The radial width of the annular groove 5c is of such a size that there is a gap between the tensioning ring 18a and the groove wall surrounding it.

The embodiment exemplified in FIG. 4, in which the same or similar parts are provided with the same reference numbers, differs from the exemplified embodiment described above in that the bearing sleeve 5a and the segments 5e are elastically biased radially outwards rather than radially inwards by the tensioning ring 18a. In this embodiment, the bearing sleeve 5a or the segments 5e work together with a bearing part surrounding them, this bearing part being formed by a hollow cylindrical bearing sleeve 11e which projects axially in a concentric manner from the toothed disc 11b and submerges into the annular groove 5c made to be the appropriate size with radial play. In this embodiment, the bearing sleeve 5a or the segments 5e and the bearing sleeve 11e form the pivot bearing 14 for the take-up reel 5.

In this exemplified embodiment, the annular groove 19 and the insertion surface 21 are arranged on the inside of the bearing sleeve 5a or segments 5e. Between the bearing sleeve 11e and the bearing sleeve 11d there is arranged an annular groove 22 open at one side. Groove 22 has such a radial width that there is a free space between the tensioning element 18 and the outer shell surface of the bearing sleeve 11d.

In the embodiment exemplified in FIG. 3, the tensioning ring 18a can be formed by a resilient pressure element which acts in its longitudinal direction, for example a compression spring in the form of a helical spring (FIG. 5) or a spring ring (FIG. 6) slit with a slot 18b, this spring being radially biased outwards.

The sliding surfaces of the sliding clutch 12 used in the invention abut one another at a round or hollow cylindrical joint 12a either directly or with a small amount of play. Only a very small radial movement—or in the case of abutment just the exertion of pressure—is required to achieve the rotational slaving based on the frictional action. Due to the low amount of radial movement, the material of the bearing sleeve 5a is stressed just slightly or not at all. No material fatigue or reduction of the frictional action as a result of material fatigue or aging therefore has to be expected. The tension F of a long life is made clear by FIG. 7 given lifetime t.

All the parts of the invention, including tensioning ring 18a and the tensioning element 18, can be made of plastic. The tensioning ring 18a is preferably made of flexible metal, especially spring steel, so that the favorable spring constants can be exploited.

To prevent the reels 4, 5 from rotating backwards, for example as a result of tensions in the backing tape 2, one of the two reels 4, 5 has an associated return stop (not illustrated) which can for example be formed by a locking pawl (not illustrated) which works together with one of the toothed wheels 11a, 11b.

In all the exemplary embodiments, it is possible and, with a view to improving the alignment of the slide faces, favorable to arrange an annular recess in the central portion of one and/or the other of the sliding surfaces of the joint 12a or to contrast the sliding surfaces Z-shaped to one another as shown by FIG. 4. In the latter embodiment, the joining together of the bearing parts is also simplified.

In the claims:

1. A sliding clutch for torque-limiting transmission of force between a reel and a rotating member, said sliding clutch comprising:
a bearing sleeve and a bearing member disposed concentrically within one another and abutting each other in a region of a circular joint, said bearing sleeve and said bearing member being rotatable about a rotational axis, wherein said bearing sleeve is radially elastically deformable transverse to the rotational axis; and
a tensioning element positioned to engage said bearing sleeve and to bias said bearing sleeve against said bearing member;
wherein:
said tensioning element presses against at least one free section of said bearing sleeve; and
torsional force is transmitted by means of frictional slaving between said bearing sleeve and said bearing member.

2. The sliding clutch according to claim 1, wherein said tensioning element comprises an open ring.

3. The sliding clutch according to claim 1, wherein said tensioning element comprises a closed ring.

4. The sliding clutch according to claim 1, wherein said free section includes an annular groove and said tensioning element extends in the annular groove.

5. The sliding clutch according to claim 1, wherein said bearing sleeve includes a base wall at an axial end and said free section is connected to said base wall and extends from said base wall in a direction parallel to the rotational axis.

6. The sliding clutch according to claim 1, wherein said bearing sleeve has at least one slit extending in a substantially axial direction.

7. The sliding clutch according to claim 6, wherein said bearing sleeve includes at least two slits and at least one free section is define between adjacent slits.

8. The sliding clutch according to claim 1, wherein said tensioning element comprises a spring ring split into four parts.

9. The sliding clutch according to claim 1, wherein said tensioning element comprises a helical spring.

10. The sliding clutch according to claim 1, wherein said tensioning element is annular and surrounds said bearing sleeve and presses radially inwards against said bearing sleeve.

11. The sliding clutch according to claim 1, wherein said tensioning element is annular and is surrounded by said bearing sleeve and presses radially outwards against said bearing sleeve.

12. The sliding clutch according to claim 1, wherein said sliding clutch is integrated in a drive connection between a supply reel and a take-up reel of a hand-held device for applying a film onto a substrate.

13. The sliding clutch according to claim 12, wherein said sliding clutch is integrated in a drive connection between the take-up reel and a rotary drive member for the take-up reel.

14. The sliding clutch according to claim 1, wherein said bearing sleeve includes a main body and said free section is separated from said main body of said bearing sleeve by a radial gap.

15. A sliding clutch for torque-limiting transmission of force between a reel and a rotating member, said sliding clutch comprising:
a bearing sleeve and a bearing member disposed concentrically within one another and abutting each other in a region of a circular joint, said bearing sleeve and said bearing member being rotatable about a rotational axis, wherein said bearing sleeve is radially elastically deformable transverse to the rotational axis; and
a tensioning element positioned to engage said bearing sleeve and to bias said bearing sleeve against said bearing member;
wherein:
said tensioning element has the form of an open ring, which extends in the circumferential direction of said bearing sleeve; and
torsional force is transmitted by means of frictional slaving between said bearing sleeve and said bearing member.

16. The sliding clutch according to 15, wherein said tensioning element presses against at least one free section of said bearing sleeve.

17. The sliding clutch according to claim 16, wherein said bearing sleeve includes a main body and said free section is separated from said main body of said bearing sleeve by a radial gap.

18. The sliding clutch according to claim 15, wherein said free section includes an annular groove and said ring extends in said annular groove.

19. A sliding clutch for torque-limiting transmission of force between a reel and a rotating member, said sliding clutch comprising:
a bearing sleeve and a bearing member disposed concentrically within one another and abutting each other in a region of a circular joint, said bearing sleeve and said bearing member being rotatable about a rotational axis, wherein said bearing sleeve is radially elastically deformable transverse to the rotational axis; and
a tensioning element positioned to engage said bearing sleeve and to bias said bearing sleeve against said bearing member;
wherein:
said tensioning element has the form of a closed ring, which extends in the circumferential direction of said bearing sleeve; and
torsional force is transmitted by means of frictional slaving between said bearing sleeve and said bearing member.

20. The sliding clutch according to 19, wherein said tensioning element presses against at least one free section of said bearing sleeve.

21. The sliding clutch according to claim 20, wherein said bearing sleeve includes a main body and said free section is separated from said main body of said bearing sleeve by a radial gap.

22. The sliding clutch according to claim 19, wherein said free section includes an annular groove and said ring extends in said annular groove.
